(19) United States
(12) Patent Application Publication
(10) Pub. No.: US 2026/0088751 A1
(43) Pub. Date: Mar. 26, 2026

(54) TRUSS FOUNDATIONS FOR AGRIVOLTAICS

(71) Applicant: Ojjo, Inc., San Rafael, CA (US)

(72) Inventor: Charles Almy, Berkley, CA (US)

(21) Appl. No.: 19/334,071

(22) Filed: Sep. 19, 2025

Related U.S. Application Data
(60) Provisional application No. 63/697,393, filed on Sep. 20, 2024.

(51) Int. Cl. H02S 20/32

(52) U.S. Cl. CPC H02S 20/32

(57) ABSTRACT

A truss foundation system is disclosed for supporting a single-axis solar tracker in agrivoltaic installations. The system includes a screw anchor foundation component having an embedment end and an opposing driving end. A Y-shaped screw cap sleeves over the driving end of the screw anchor and includes a lower portion and a pair of upper portions extending at reciprocal angles relative to a vertical midline. A pair of truss legs are connected to the respective upper portions of the screw cap and extend upwardly to support the tracker structure.

### RELATED APPLICATION

This application claims the benefit of U.S. Provisional Ser. No. 63/697,393, filed Sep. 20, 2024, the entire contents of which are incorporated herein by reference.

### BACKGROUND

Tracts of open space that can be dedicated to solar energy generation are becoming scarcer in industrialized countries. At the same time, clean energy mandates require that solar power be deployed. This has created competition for suitable land. This competition has fostered the rise of agrivoltaics. Building on the sustainable farming goals of higher yields, less run-off and reduced water consumption, agrivoltaics, refers to blending agricultural and solar energy production on the same land. Solar panels are typically positioned above crops or other flora as fixed tilt or even single-axis tracker arrays. Combining power generation with agriculture enhances land use efficiency, can diminish water needs relative to unshaded crops, and creates new income sources for farmers.

One challenge to agrivoltaics relative to conventional utility scale solar is how to elevate the array sufficiently high and space components sufficiently far apart to enable crops to be grown as well as to provide horizontal and vertical clearance for agricultural equipment to plant, harvest, and plow the rows. Conventionally, this has been done by taking the standard H-pile foundation and lengthening it to 40 feet or more to provide 10+ feet for embedment and another 30+ feet of elevation above grade. For standard W6×9 or W6×12 solar H-pile, this can mean a pile that weighs as much as 500 pounds. Such piles require large crews of workers and very large equipment.

To solve this problem, the various embodiments disclosed herein provide truss foundations for agrivoltaics that utilize less steel, provide for shallower embedment depths and that are easier to install than conventional monopile foundations at the heights required for agrivoltaics.

### BRIEF DESCRIPTION OF THE DRAWINGS

The following drawings are illustrative of particular examples of the present invention and therefore do not limit the scope of invention. The drawings are not necessarily to scale, though embodiments can include the scale illustrated, and are intended for use in conjunction with the explanations in the following detailed description wherein like reference characters denote like elements. Examples of the present invention will hereinafter be described in conjunction with the appended drawings.

FIG. 1 is a side view of a prior art single-axis tracker used in an agrivoltaics application.

FIG. 2 is a side view of a single-axis tracker used in an agrivoltaics application according to an embodiment of the present disclosure.

FIG. 3 is an exploded view of screw anchor foundation component and a corresponding connecting portion according to an embodiment of the present disclosure.

FIG. 4A is an exploded view of a truss cap according to an embodiment of the present disclosure.

FIG. 4B is a side view of a truss cap with an external bearing housing according to an embodiment of the present disclosure.

FIG. 5 is a schematic showing the force vectors in the truss foundation according to an embodiment of the present disclosure.

FIG. 6 is a side view of another truss foundation for supporting a single-axis tracker with the tracker bearing and the torque tube omitted according to an embodiment of the present disclosure.

FIG. 7 is a side view of another truss foundation for supporting a single-axis tracker in an agrivoltaics application according to an embodiment of the present disclosure.

FIG. 8 is an exploded view of the upper portion of the truss cap according to an embodiment of the present disclosure.

### DESCRIPTION

The following description is intended to convey a thorough understanding of the embodiments described by providing a number of specific embodiments and details involving truss foundations for single-axis trackers. It should be appreciated, however, that the present invention is not limited to these specific embodiments and details, which are exemplary only. It is further understood that one possessing ordinary skill in the art in light of known systems and methods, would appreciate the use of the invention for its intended purposes and benefits in any number of alternative embodiments, depending upon specific design and other needs.

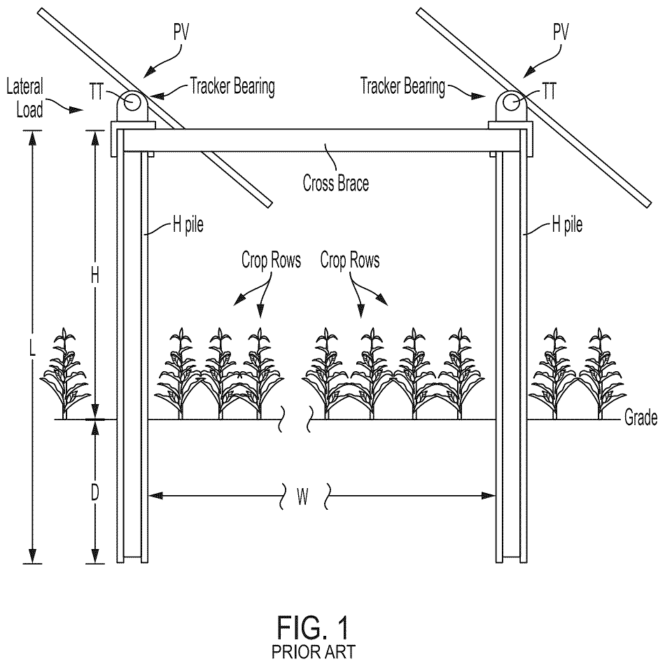

Starting with reference to FIG. 1, this figure shows a generic conventional single-axis tracker used in an agrivoltaics application. The tracker, as shown in this example, is a conventional single-axis tracker where the torque tube rotates about its own axis while captured within a bearing. The bearings sit atop standard wide flange solar I-beams known in the art as H-piles. The lower portion of the bearing assembly has flange that extends down over the flanges of the beam. Typically, holes are predrilled in the beams to match the hole pattern on the flanges of the bearing assembly. In a standard solar array application, the H-pile alone is sufficient to support the tracker components, however, due to the unusual height of the agrivoltaics tracker, in the example of FIG. 1, a cross beam is used to connect the H-pile in one row to the H-pile in an adjacent row. Otherwise, the function of the tracker shown in FIG. 1 is same as that in conventional utility-scale power plant applications where the panels slowly move from East-facing to West-facing each day to stay orthogonal to the sun.

In this example, adjacent rows are separated by a distance W. Between each H-pile is a space for growing crops and allowing for access for agricultural equipment like tractors and the like. The distance between the cross member and grade may be thirty feet or more. The tracker is situated high enough to enable this equipment to pass through. This requires them to have a length L equivalent to the height H plus the depth of embedment D. A general rule of thumb for depth versus length is ⅓. So, to achieve a height of 30 feet, the H-pile needs to be 45 feet long with 15 feet of embedded depth. With a W6×9 pile, that equates to 9*45 or over 400 pounds of weight; for a W6×12, nearly 550 pounds. This will require an extremely large pile driving machine to lift the pile and orient the top end of it 45 feet above the ground to begin driving it.

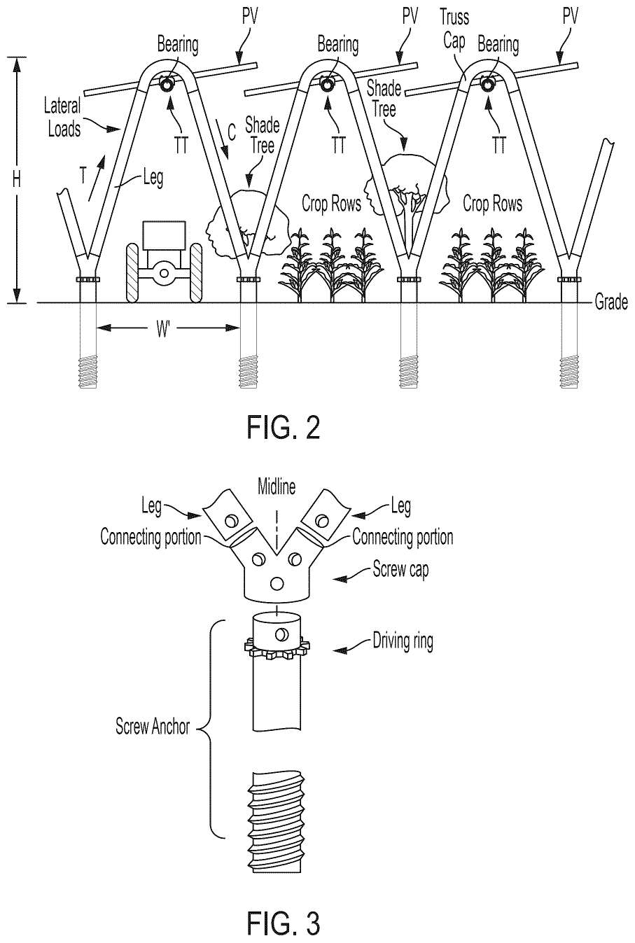

Turning now to FIG. 2, this Figure shows a truss foundation for supporting a single-axis tracker in an agrivoltaics application in accordance with various exemplary embodiments of the disclosure. In the exemplary embodiments shown in FIG. 2, H piles have been replaced with a screw anchor foundation components. This component has several advantages. First, it is much smaller than the 40+ foot H-pile and can be loaded on the driving machine by a single person. Second, the embedment depth is far shallower; all embedment work is done near the ground. A driving ring near the top of the screw anchor is engaged by chuck of a rotary driver to facilitate embedment. A Y shaped screw cap sits on the upper end of the screw anchor. As shown, the screw cap has a through-hole which when mated to the screw anchor, aligns with a corresponding hole on it to enable a single fastener such as a bolt or pin to pass through both, locking the two structures together. The upper ends of the Y-shaped screw cap angle off at reciprocal angles with respect to a vertical midline. Upper leg sections, which, as depicted are straight sections of tube, are sleeved over each connecting portion to span the row DISTANCE W′. The leg section from one screw cap projects upwards at angle where it is joined at its distal end to the leg section extending from the adjacent screw cap. A truss cap such as that shown in 4A may be used to join these two leg sections to form a unitary truss structure. As shown in 4A, the truss cap has a pair of crimp connectors. In various embodiments, the truss cap is lowered down by a person operating an off-road scissor lift, boom lift or the like until the crimp connectors are received within the distal end of each leg section. Then, in various embodiments, a hydraulic crimping device may be used to form crimp joints between the two, deforming the leg sections into the channels formed in the crimp connectors. Alignment tabs on the truss cap may align with a jig on the crimper to ensure that the blind crimps deform the leg sections into the voids rather than trying to deform them into solid metal.

Once both crimps are affected, the resulting structure is like that shown in FIG. 2. This process is repeated down the tracker row until the row is completed. It should be appreciated that in various embodiments, the truss cap and leg sections may be formed from a single elongated tube that is bent into the general A-frame shape shown in FIG. 2. In such embodiments, these A-frame structures are picked up using a reach fork or other suitable device and slowly lowered onto the screw caps of two adjacent screw anchors so that they can be secured to them. In this example, the crop row is under the A-frame structure, however, trees may also be planted along each North South row of foundations. The screw anchors may also provide a support structure for attaching guy wires or other supports to preserve the vertical alignment of such trees. The legs and/or screw caps may also be used to elevate irrigation hoses above the ground to run over and/or proximate to the crop rows.

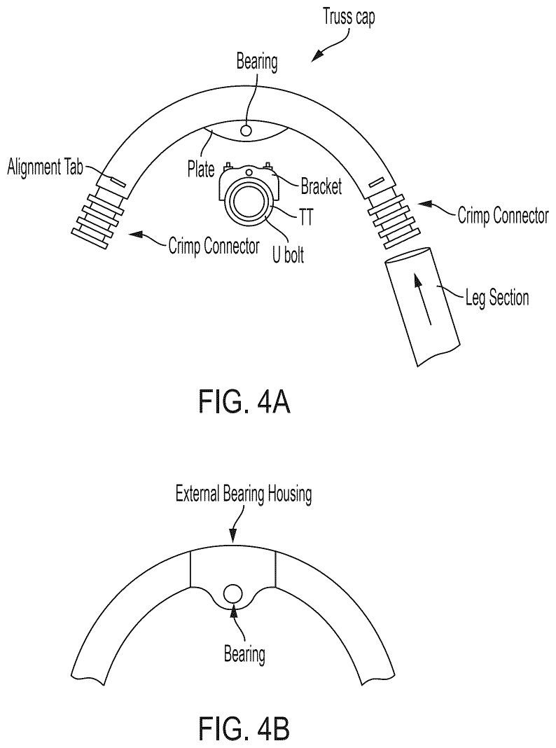

FIGS. 4A and 4B show alternative truss caps usable with the various embodiments of the invention. Starting with 4A, in this example, a bearing plate and bearing are welded to the underside of the apex of the truss cap. In various embodiments, this bearing may receive a bearing pin from which the torque tube is suspended. A bracket and U-bolt may be used to capture the torque tube and to attach it to the bearing pin seated in the bearing. In such embodiments, the left and right sides of the truss cap will bound the extent to which the torque can swing in either the East or West directions.

4B shows what in some embodiments, is a different truss cap. In these embodiments, a separate bearing housing structure is attached to the approximate middle of the truss cap that includes a bearing. In such embodiments, the torque tube may be attached to the bearing via the same structure as that shown in 4A.

It should be appreciated by those of ordinary skill in the art that the truss cap will not be needed in embodiments, where two adjacent legs are formed from a single tube of steel. In such embodiments, the steel is bent at the middle to the same shape provided by the truss cap. In such embodiments, the bearing plate and bearing may be welded to the approximate middle. Alternatively, if a separate BHA is used, as shown in FIG. 4B, the BHA may be attached to the approximate middle of the bent leg tube.

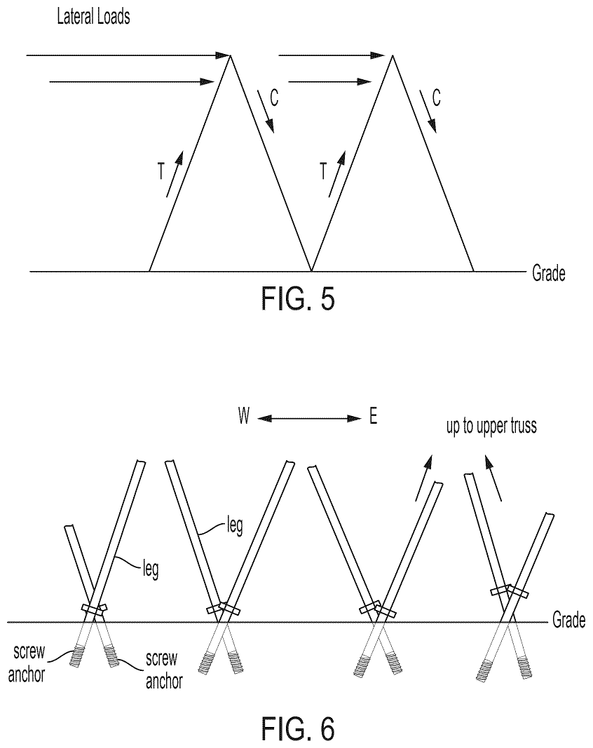

Turning to FIG. 5, this figure is a force diagram to show the efficiency of the foundation design shown in FIG. 2 relative to the H-pile support of FIG. 1. As wind strikes the panels on the tracker array, generating lateral loads, those loads cause tension and compression in the windward and leeward legs respectively. With each screw anchor supporting a leeward leg and windward leg, the tensile and compressive forces substantially cancel each other out. The horizontal component of the forces will be additive, but that component is attenuated by the angle of the legs.

Turning to FIG. 6, this figure shows another truss foundation for supporting a single-axis tracker in an agrivoltaics application. In this example, the apex components including the tracker bearing and torque tube have been intentionally omitted. Those of ordinary skill in the art will appreciate that those components may be the same as those shown in FIGS. 2, 3, 4A and 4B. The main difference between this embodiment and that shown in FIG. 2 is that instead of each screw anchor supporting a pair of legs, the screw anchors are driven at the intended leg angle and support only one leg. That is, each truss is independent of the adjacent truss. Adjacent screw anchors are out of plane with each other or staggered so that the Westward screw anchor of the adjacent pair points right and Eastward leg of the adjacent pair points left to use the orientation shown in the drawings. The pairs of adjacent legs are not interconnected so each truss stands on its own. In this way, no forces are transmitted between rows. By offsetting the legs in a crisscross pattern, they occupy relatively the same space in the North-South direction (direction of the tracker row) thereby preserving the spacing between adjacent foundation rows for crops to be grown and equipment to be operated.

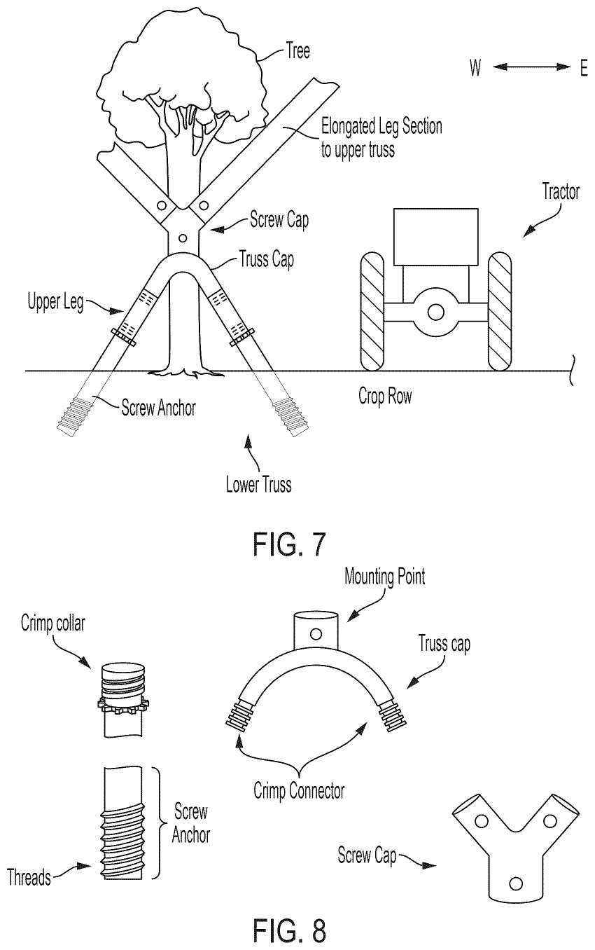

Turning now to FIGS. 7 and 8, these figures show yet another truss foundation for supporting a single-axis tracker in an agrivoltaics application according to various exemplary embodiments. The foundation here consists of individual truss foundations supporting above ground truss foundations which in turn support the single-axis tracker. At the base, a pair of screw anchors are driven at angles to one another straddling an intended North-South tracker row. The plane created by the space between the legs is orthogonal to the North-South tracker row. The base or lower truss foundation shown in FIG. 7 is a standard truss foundation such as that manufactured and sold by Ojjo Inc of San Rafael, CA known commercially as an Earth Truss. It consists of a pair of driven screw anchors, a pair of upper leg sections and a truss cap unifying the truss structure. The truss cap and the screw anchor have crimp connectors with a series of channels formed in them so that the upper legs can be crimped over them at the areas of overlap. The upper portion of the truss cap, as shown in FIG. 8, has a mounting post. An adapter, labeled screw cap in the figures, is similar in structure to that shown in FIGS. 2 and 3. The screw cap is sleeved over the mounting post of the truss cap and then leg portions of the truss that supports the single-axis tracker are sleeved down over the upper ends of the Y-shaped screw cap. Pins or bolts may be passed through the holes in the upper legs, screw cap and truss cap to unify these four structures. At the apex of the upper truss, elongated leg sections stemming from two different adjacent lower truss foundations come together at another truss cap.

It should be appreciated that the embodiments described and claimed herein are exemplary only. Those of ordinary skill in the art will appreciate modifications and substitutions that retain the spirit and scope of the invention.

1. A truss foundation for supporting a single-axis tracker in an agrivoltaics application comprising:
a first screw anchor foundation component having an embedment end and an opposing driving end;
a first screw cap having a Y-shape and a lower portion configured to sleeve over the opposing driving end of the first screw anchor foundation component and a pair of upper portions extending away at reciprocal angles with respect to a vertical midline bisecting the first screw cap; and
a pair of truss legs extending up and away from respective upper portions of the first screw cap.

2. The truss foundation according to claim 1, wherein each of the pair of truss legs terminates at a truss cap that joins each of the pair of truss legs to a respective adjacent truss leg connected to another screw cap having a Y-shape.

3. The truss foundation according to claim 2, wherein the truss cap comprises a tracker bearing for suspending a tracker torque tube.

4. The truss foundation according to claim 1, wherein each of the pair of truss legs is one leg of a unitary truss leg pair configured to be attached to respective screw caps of adjacent screw anchor foundations.

5. The truss foundation according to claim 4, further comprising a bearing housing comprising a bearing plate having a tracker bearing, the bearing housing configured to attach to the unitary truss leg pair at an approximate middle of a bent portion of the unitary truss leg pair.

6. The truss foundation according to claim 1, further comprising:
a second screw anchor foundation component having an embedment end and an opposing driving end;
a second screw cap having a Y-shape and having a lower portion configured to sleeve over the opposing driving end of the second screw anchor foundation component and a pair of upper portions extending away at reciprocal angles with respect to a vertical midline bisecting the second screw cap; and
a third truss leg extending up and away from one of the pair of upper portions of the second screw cap.

7. The truss foundation according to claim 6, further comprising a fourth truss leg extending up and away from the other of the pair of upper portions of the second screw cap.

8. A truss foundation for supporting a single-axis tracker in an agrivoltaics application comprising:
i. a first foundation comprising:
a. a screw anchor comprising an embedded end and a driving end, the driving end further comprising a driving ring; and
b. a screw cap configured to couple to the driving end of the screw anchor, the screw cap comprising a pair of connecting portions extending upwardly away from the screw anchor at reciprocal angles;
ii. a second foundation comprising:
a. a screw anchor comprising an embedded end and a driving end, the driving end further comprising a driving ring; and
b. a screw cap configured to couple to the driving end of the screw anchor, the screw cap comprising a pair of connecting portions extending upwardly away from the screw anchor at reciprocal angles; and
iii. a first tracker support spanning between the first and second foundations, the first tracker support comprising:
a. a first leg portion coupled to one of the pair of connecting portions of the screw cap of the first foundation;
b. a second leg portion coupled to one of the pair of connecting portions of the screw cap of the second foundation; and
c. a bent portion connecting distal ends of the first leg portion and the second leg portion.

9. The truss foundation according to claim 8, wherein the first leg portion, the second leg portion, and the bent portion of the first tracker support are formed from a single tube.

10. The truss foundation according to claim 9, further comprising a bearing housing comprising a bearing coupled to the bent portion of the first tracker support, the bearing configured to receive a bearing pin to support a torque tube.

11. The truss foundation according to claim 8, wherein the bent portion comprises a truss cap.

12. The truss foundation according to claim 8, further comprising:
iv. a third foundation comprising:
a. a screw anchor comprising an embedded end and a driving end, the driving end further comprising a driving ring; and
b. a screw cap configured to couple to the driving end of the screw anchor, the screw cap comprising a pair of connecting portions extending upwardly away from the screw anchor at reciprocal angles; and
v. a second tracker support spanning between the first and third foundations, the second tracker support comprising:
a. a first leg portion coupled to the other of the pair of connecting portions of the screw cap of the first foundation;
b. a second leg portion coupled to one of the pair of connecting portions of the screw cap of the third foundation; and
c. a bent portion connecting distal ends of the first leg portion and the second leg portion.

13. A truss foundation for supporting a single-axis tracker in an agrivoltaics application comprising:
a pair of adjacent screw anchor foundation components embedded at opposing angles to one other with respect to plumb;
a pair of upper leg sections, each extending a main axis of respective ones of the pair of adjacent screw anchor foundation components;
a truss cap configured to join the pair of upper leg sections together, the truss cap having a support post projecting from a middle portion thereof;
a first screw cap having a Y-shape and configured to sleeve over the support post; and
a pair of elongated leg sections extending up and away from respective upper portions of the first screw cap.

14. The truss foundation according to claim 13, wherein each leg of the pair of elongated leg sections terminates at a second truss cap that joins each of the elongated leg sections with an elongated leg section of an adjacent truss foundation.

15. The truss foundation according to claim 14, wherein the second truss cap comprises a tracker bearing for suspending a tracker torque tube.
